(19) United States
(12) Patent Application Publication
(10) Pub. No.: US 2026/0099714 A1
(43) Pub. Date: Apr. 9, 2026

(54) PREDICTION DEVICE, PREDICTION METHOD, AND NON-TRANSITORY COMPUTER READABLE MEDIUM STORING PREDICTION PROGRAM FOR SUPPORTING DECISION MAKING

(71) Applicant: NEC Corporation, Tokyo (JP)

(72) Inventors: Kosuke AKIMOTO, Tokyo (JP); Masafumi Oyamada, Tokyo (JP)

(73) Assignee: NEC Corporation, Tokyo (JP)

(21) Appl. No.: 19/338,324

(22) Filed: Sep. 24, 2025

(30) Foreign Application Priority Data
Oct. 8, 2024 (JP) 2024-176662

(51) Int. Cl. G06N 3/084; G06F 18/2413; G06F 18/27; G06N 3/0475

(52) U.S. Cl. CPC G06N 3/084; G06F 18/24147; G06F 18/27; G06N 3/0475

(57) ABSTRACT

A prediction device capable of predicting performance of a language model in a case where the language model is trained using a plurality of languages is implemented. The prediction device includes an acquisition unit for acquiring a model size of the language model for a target language to be trained using the plurality of languages, a training data amount used for learning processing, and a target language ratio indicating a ratio of a data amount of the target language in the training data amount, and a prediction unit for predicting a loss of the language model using a product of a function depending on the model size and the training data amount and a constant power of the target language ratio.

### INCORPORATION BY REFERENCE

This application is based upon and claims the benefit of priority from Japanese patent application No. 2024-176662, filed on Oct. 8, 2024, the disclosure of which is incorporated herein in its entirety by reference.

### TECHNICAL FIELD

The present disclosure relates to a prediction device, a prediction method, and a prediction program for supporting decision making.

### BACKGROUND ART

A technique for predicting performance by training a language model is known. For example, “Data Mixing Made Efficient: A Bivariate Scaling Law for Language Model Pretraining” (Ce Ge et al., [online], Jun. 11, 2024, Internet <URL: https://arxiv.org/pdf/2405.14908v2>) describes that in a case where language models of a plurality of domains are trained, the loss of the language model follows a power law with respect to the ratio of the domains.

### SUMMARY

In the technique described in “Data Mixing Made Efficient: A Bivariate Scaling Law for Language Model Pretraining” (Ce Ge et al., [online], Jun. 11, 2024, Internet <URL: https://arxiv.org/pdf/2405.14908v2>), a configuration for predicting performance in a case where a language model is trained using a plurality of languages has not been studied.

The present disclosure has been made in view of the above problems, and an example object thereof is to provide a technology for predicting performance of a language model in a case where the language model is trained using a plurality of languages.

A prediction device according to an example aspect of the present disclosure includes an acquisition means for acquiring a model size of a language model for a target language to be trained using a plurality of languages, a training data amount used for learning processing of the language model, and a target language ratio indicating a ratio of a data amount of the target language in the training data amount, and a prediction means for predicting a loss of the language model by using a product of a function depending on the model size and the training data amount and a constant power of the target language ratio.

A prediction method according to an example aspect of the present disclosure includes acquisition processing of acquiring, by at least one processor, a model size of a language model for a target language to be trained using a plurality of languages, a training data amount used for learning processing of the language model, and a target language ratio indicating a ratio of a data amount of the target language in the training data amount, and prediction processing of predicting, by the at least one processor, a loss of the language model by using a product of a function depending on the model size and the training data amount and a constant power of the target language ratio.

A prediction program according to an example aspect of the present disclosure is a program for causing a computer to function as a prediction device, the program causing the computer to function as an acquisition means for acquiring a model size of a language model for a target language to be trained using a plurality of languages, a training data amount used for learning processing of the language model, and a target language ratio indicating a ratio of a data amount of the target language in the training data amount, and a prediction means for predicting a loss of the language model by using a product of a function depending on the model size and the training data amount and a constant power of the target language ratio.

According to an example aspect of the present disclosure, there is an example effect that a technique of predicting performance of a language model in a case where the language model is trained using a plurality of languages can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of a prediction device according to the present disclosure;

FIG. 2 is a flowchart illustrating a flow of a prediction method according to the present disclosure;

FIG. 3 is a graph illustrating a loss of an LLM in a case where a model size, a training data amount, and a target language ratio are changed in multilingual one-stage learning according to the present disclosure;

FIG. 4 is a graph illustrating a loss of an LLM in a case where a model size, a training data amount, a target language ratio, and the number of epochs are changed in multilingual one-stage learning according to the present disclosure;

FIG. 5 is a block diagram illustrating a configuration of the prediction device according to the present disclosure;

FIG. 6 is a flowchart illustrating a flow of a prediction method according to the present disclosure; and

FIG. 7 is a block diagram illustrating a configuration of a computer that functions as the prediction device according to the present disclosure.

### EXAMPLE EMBODIMENT

Hereinafter, example embodiments of the present disclosure will be exemplified. However, the present disclosure is not limited to the following illustrative example embodiments, and various modifications can be made within a scope described in the claims. For example, example embodiments obtained by appropriately combining technologies (some or all of things or methods) adopted in the following illustrative example embodiments can also be included in the scope of the present disclosure. Example embodiments obtained by appropriately omitting some of the technologies adopted in the following illustrative example embodiments can also be included in the scope of the present disclosure. Effects mentioned in the following illustrative example embodiments are examples of effects expected in the illustrative example embodiments, and do not define extension of the present disclosure. In other words, example embodiments that do not provide the effects mentioned in the following illustrative example embodiments can also be included in the scope of the present disclosure.

### First Illustrative Example Embodiment

A first illustrative example embodiment that is an example of the example embodiments of the present disclosure will be described in detail with reference to the drawings. The present illustrative example embodiment is a basic form of each illustrative example embodiment to be described below. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technology illustrated in the drawings referred to for describing the present illustrative example embodiment can also be adopted in another illustrative example embodiment included in the present disclosure within a range in which no particular technical problem occurs.

### (Configuration of Prediction Device 1)

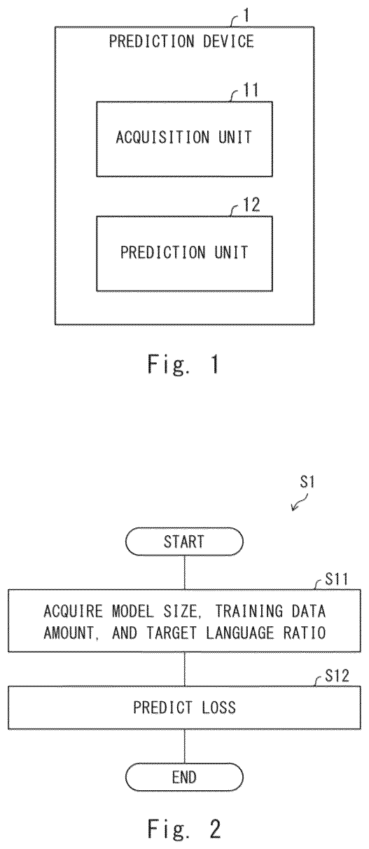

A configuration of a prediction device 1 will be described with reference to FIG. 1. FIG. 1 is a block diagram illustrating a configuration of the prediction device 1. As illustrated in FIG. 1, the prediction device 1 includes an acquisition unit 11 and a prediction unit 12. The acquisition unit 11 and the prediction unit 12 implement an acquisition means and a prediction means, in the present illustrative example embodiment.

### (Acquisition Unit 11)

The acquisition unit 11 acquires the model size of the language model for the target language to be trained using the plurality of languages, the training data amount used for the learning processing of the language model, and the target language ratio indicating the ratio of the data amount of the target language among the training data amount. The acquisition unit 11 supplies the acquired model size, training data amount, and target language ratio to the prediction unit 12.

### (Prediction Unit 12)

The prediction unit 12 predicts a loss of the language model using the product of the function depending on the model size and the training data amount and the constant power of the target language ratio.

### (Effects of Prediction Device 1)

As described above, the prediction device 1 employs a configuration including the acquisition unit 11 that acquires the model size of the language model for the target language to be trained using the plurality of languages, the training data amount used for the learning processing of the language model, and the target language ratio indicating the ratio of the data amount of the target language in the training data amount, and the prediction unit 12 that predicts a loss of the language model using the product of the function depending on the model size and the training data amount and the constant power of the target language ratio.

Therefore, according to the prediction device 1, it is possible to obtain an effect of predicting the performance of the language model in a case where the language model is trained using a plurality of languages.

### (Flow of Prediction Method S1)

A flow of a prediction method S1 will be described with reference to FIG. 2. FIG. 2 is a flowchart illustrating the flow of the prediction method S1. As illustrated in FIG. 2, the prediction method S1 includes acquisition processing S11 and prediction processing S12.

### (Acquisition Processing S11)

In the acquisition processing S11, the acquisition unit 11 acquires the model size of the language model for the target language to be trained using the plurality of languages, the training data amount used for the learning processing of the language model, and the target language ratio indicating the ratio of the data amount of the target language among the training data amount. The acquisition unit 11 supplies the acquired model size, training data amount, and target language ratio to the prediction unit 12.

### (Prediction Processing S12)

In the prediction processing S12, the prediction unit 12 predicts a loss of the language model using the product of the function depending on the model size and the training data amount and the constant power of the target language ratio.

### (Effect of Prediction Method S1)

As described above, the prediction method S1 employs a configuration including acquisition processing S11 in which the acquisition unit 11 acquires the model size of the language model for the target language to be trained using the plurality of languages, the training data amount used for the learning processing of the language model, and the target language ratio indicating the ratio of the data amount of the target language in the training data amount, and prediction processing S12 in which the prediction unit 12 predicts a loss of the language model using the product of the function depending on the model size and the training data amount and the constant power of the target language ratio. Therefore, according to the prediction method S1, the same effect as that of the prediction device 1 described above can be obtained.

### Second Illustrative Example Embodiment

A second illustrative example embodiment that is an example of the example embodiments of the present disclosure will be described in detail with reference to the drawings. Components that have the same functions as the components described in the above-described illustrative example embodiment are denoted by the same reference signs, and description of the components will be appropriately omitted. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technique illustrated in each of the drawings referred to for description of the present illustrative example embodiment can be employed in the other illustrative example embodiments included in the present disclosure within a range in which no particular technical problem occurs.

Learning a language model (hereinafter, also referred to as “LLM (Large Language Models)”) requires a large text corpus. However, languages other than English have a relatively small text corpus. Therefore, the following method is known as a method for training a language model using a language having a small resource amount of a text corpus as a target language.
Method of performing learning by repeatedly using the same text corpus a plurality of times (multi-epoch learning)·
Method of performing learning using a text corpus of another language different from the target language in addition to a text corpus of the target language (multilingual learning)
Method of performing two-stage learning by changing in stages a language ratio between a target language and another language in multilingual learning (two-stage learning)

However, in a case where the language model is trained by combining the above-described methods, the learning setting (hyperparameter) increases, and thus, the cost increases if exhaustive search is performed.

Therefore, the engineer who trains the language model has heuristically narrowed down the search space based on the analysis result obtained in the past regarding the performance change of the language model by the learning setting. However, the analysis related to the learning setting of the language model performed in the past is limited, and there is a problem that the optimal search space cannot be narrowed in a case where the LLM is trained by combining the above-described methods.

Therefore, the inventors of the present disclosure have conducted studies to narrow down a search space of a learning setting expected to obtain high performance in a case where a language model having a language with a small resource amount as a target language is trained by using a combination of a part or all of the multi-epoch learning, the multilingual learning, and the two-stage learning described above.

As an example, the present inventor has obtained knowledge that, in a case where an LLM for a target language is trained using a plurality of languages, performance (loss) of an obtained language model follows a power law of a target language ratio that is a ratio of a data amount of the target language in a training data amount used for learning processing.

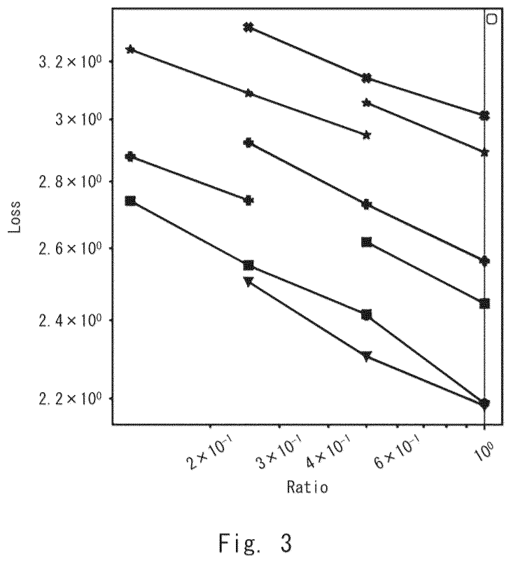

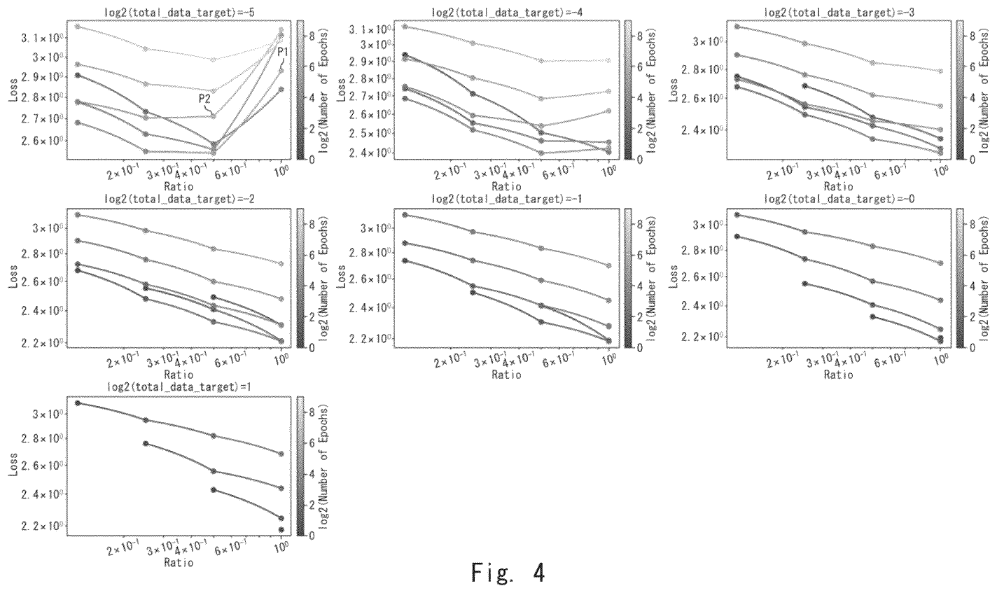

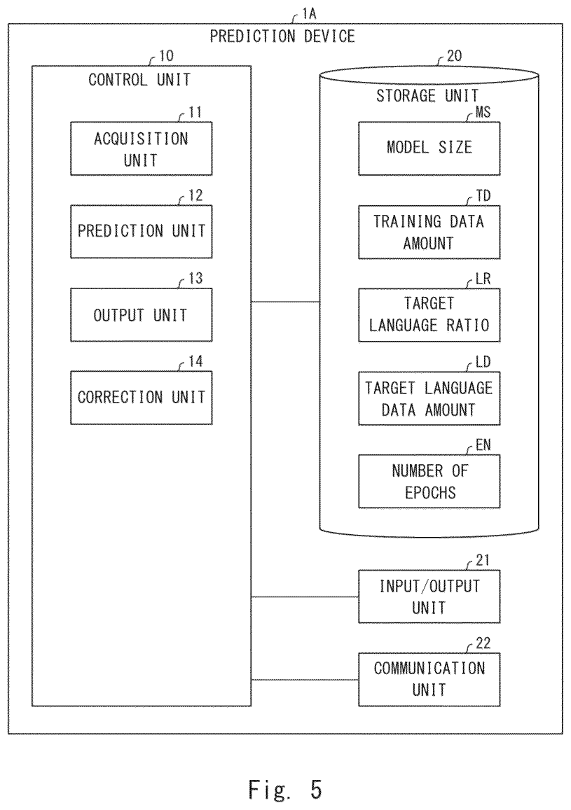

FIGS. 3 and 4 illustrate graphs that are the basis of the findings obtained by the present inventor. FIG. 3 is a graph illustrating a loss of an LLM in a case where a model size, a training data amount, and a target language ratio are changed in multilingual one-stage learning. FIG. 4 is a graph illustrating a loss of an LLM in a case where a model size, a training data amount, a target language ratio, and the number of epochs are changed in multilingual one-stage learning.

The graph illustrated in FIG. 3 is a double logarithmic graph in which the horizontal axis represents the target language ratio (in this example, the ratio of Japanese) and the vertical axis represents the loss of an LLM that could be achieved in the relevant target language ratio. The difference between the lines indicates the difference between the model size and the training data amount, and these lines are substantially parallel. In the graph illustrated in FIG. 3, the number of epochs is 4 or less, which is less affected by overfitting.

From the graph shown in FIG. 3, the present inventor has obtained knowledge that in a case where the number of epochs is small, the loss of an LLM can be predicted by a product of a function (f(model size, data amount)) depending on the model size and the data amount and a constant power of the target language ratio (target language ratio\hat{ }constant).

Each of the plurality of graphs illustrated in FIG. 4 is a double logarithmic graph in which the horizontal axis is the target language ratio (in this example, the ratio of Japanese) and the vertical axis is the loss of an LLM that could be achieved in the relevant target language ratio. The difference between the plurality of graphs illustrated in FIG. 4 indicates the difference in the data amount of the target language, and the data amount of the target language is arranged in the upper left, the upper center, the upper right, the left center, the center, the right center, and the lower left in the ascending order. In FIG. 4, the difference between the lines indicates the difference in the model size. In FIG. 4, the color density of the line represents the number of epochs, and the darker the color, the smaller the number of epochs.

In the plurality of graphs illustrated in FIG. 4, the calculation resource amount of the processing of training the LLM is the same. Therefore, in FIG. 4, it can be seen that the smaller the model size, the larger the consumed data amount, and in the same graph, the smaller the model size, the larger the number of epochs.

In FIG. 4, in a portion where the number of epochs is small (color is dark), the lines are substantially parallel as in FIG. 3. On the other hand, in a portion where the number of epochs is large (color is light), as the number of epochs is large, the loss is shifted in a direction in which the loss is large (a direction in which the performance is poor) (the loss shifts upward).

Further, as shown in the upper left graph of FIG. 4, the degree of the upward shift of loss does not depend only on the number of epochs. For example, the point P1 and the point P2 in the upper left graph of FIG. 4 have substantially the same number of epochs, but the point P1 has a larger degree of the upward shift of loss.

As described above, from the graph on the upper left of FIG. 4, the present inventor has obtained knowledge that if the data amount of the target language to be repeated is the same, the data amount that an LLM can memorize increases as the model size increases, overfitting easily occurs, and the degree of the upward shift of loss increases.

The prediction device 1A and each processing by the prediction device 1A described below are based on the above-described knowledge, and are based on the inventor's unique point of view.

### (Outline of Prediction Device 1A)

The prediction device 1A is a device that predicts the performance of the LLM after learning. As an example, the prediction device 1A refers to the model size MS of the LLM in a case where the LLM for the target language is trained using a plurality of languages, the training data amount TD used for the learning processing of the LLM, and the target language ratio LR indicating the ratio of the data amount of the target language in the training data amount, and predicts the loss as the performance of the LLM.

The plurality of languages in which the LLM is trained include a target language and one or more languages other than the target language. The “language” in the present disclosure is a natural language such as Japanese and English. The present disclosure may be configured to predict a loss in a case where the LLM of the target domain is trained using “a plurality of domains (specific fields such as dialect and medicine)” instead of “a plurality of languages”.

The prediction device 1A corrects the predicted loss with reference to the model size MS, the target language data amount LD, and the epoch number EN. As an example, the prediction device 1A may correct the predicted loss in a case where the value of the epoch number EN is a predetermined value (for example, 4) or more.

### (Configuration of Prediction Device 1A)

A configuration of a prediction device 1A will be described with reference to FIG. 5. FIG. 5 is a block diagram illustrating a configuration of the prediction device 1A. As illustrated in FIG. 5, the prediction device 1A includes a control unit 10, a storage unit 20, an input/output unit 21, and a communication unit 22.

### (Storage Unit 20)

The storage unit 20 stores data to be referred to by the control unit 10. Examples of the storage unit 20 include the model size MS of the LLM to be trained, the training data amount TD used for the learning processing of the LLM, the target language ratio LR indicating the ratio of the data amount of the target language in the training data amount, the target language data amount LD to be repeated, and the epoch number EN.

The training data amount TD used for the learning processing of an LLM indicates the total amount of training data used in the learning processing.

The target language ratio LR indicates a ratio of the data amount of the target language in the entire learning processing in the training data amount.

The target language data amount LD (hereinafter, also simply referred to as a “target language data amount LD”) to be repeated indicates the amount of target language data used in one learning.

That is, in a case where the value of the training data amount TD is D, the value of the target language ratio LR is r, the value of the target language data amount LD is D_repeat, and the value of the epoch number EN is k, the following Expression (1) is established.

$$D \times r = D\_repeat \times k \qquad ( 1 )$$

### (Input/Output Unit 21)

The input/output unit 21 is an interface with an input device that receives an input of data and an output device that outputs data. Examples of the input device include, but are not limited to, a microphone, a camera, a line-of-sight input device, a keyboard, and a touch pad. Examples of the output device include, but are not limited to, a speaker and a liquid crystal display.

### (Communication Unit 22)

The communication unit 22 is an interface for transmitting and receiving data via a network. Examples of the communication unit 22 include, but are not limited to, communication chips in various communication standards such as Ethernet (registered trademark), Wi-Fi (registered trademark), and wireless communication standards of mobile data communication networks, and connectors compliant with USB.

### (Control Unit 10)

The control unit 10 controls each component included in the prediction device 1A. As illustrated in FIG. 5, the control unit 10 includes an acquisition unit 11, a prediction unit 12, an output unit 13, and a correction unit 14. The acquisition unit 11, the prediction unit 12, the output unit 13, and the correction unit 14 implement acquisition means, prediction means, output means, and correction means in the present illustrative example embodiment.

### (Acquisition Unit 11)

The acquisition unit 11 acquires data supplied from the input/output unit 21 or the communication unit 22. The acquisition unit 11 stores the acquired data in the storage unit 20. As an example, the acquisition unit 11 acquires the model size MS, the training data amount TD, and the target language ratio LR. As another example, the acquisition unit 11 acquires the target language data amount LD and the epoch number EN.

### (Prediction Unit 12)

The prediction unit 12 predicts a loss of an LLM. The prediction unit 12 stores the predicted loss in the storage unit 20. As an example, the prediction unit 12 predicts the loss of an LLM with reference to the model size MS, the training data amount TD, and the target language ratio LR.

More specifically, assuming that the value of the model size MS is N, the value of the training data amount TD is D, and the value of the target language ratio LR is r, the prediction unit 12 predicts the value L of the loss of an LLM using the following Expression (2).

$$L ( N , D , r ) = f ( N , D ) \times r \hat{} d \qquad ( 2 )$$

Here, f(N, D) is defined as the following Expression (3) based on the fact that f(N, D) is r=1 in Expression (2), that is, a case of single-language learning of only the already-known target language.

$$f ( N , D ) = A / N \hat{} a + B / D \hat{} b + C \qquad ( 3 )$$

Here, A, B, and C are parameters, and as an example, an LLM can be trained by using only a target language and using model sizes and training data amounts of various values, and can be estimated by using the method described in Reference Literature 1.

Reference Literature 1: Hoffmann, Jordan, et al. “Training compute-optimal large language models.” arXiv preprint arXiv: 2203.15556 (2022)
d in Expression (2) is also a parameter, and as an example, it is possible to fix the model size, train an LLM using training data amounts of various values and target language ratios, and estimate the LLM using the method described in Reference Literature 2.

Reference Literature 2: Ge Ce, et al. “Data Mixing Made Efficient: A Bivariate Scaling Law for Language Model Pretraining.” arXiv preprint arXiv: 2405.14908 (2024)

### (Output Unit 13)

The output unit 13 outputs data via the input/output unit 21 or the communication unit 22. As an example, the output unit 13 outputs information indicating a loss. Here, the information indicating the loss output by the output unit may be information indicating the loss predicted by the prediction unit 12 or information indicating the loss corrected by the correction unit 14 described later. With this configuration, the output unit 13 can notify the user of the loss in a case where an LLM is trained using the model size MS, the training data TD, and the target language ratio LR. Alternatively, the output unit 13 can notify the user of the loss in a case where the LLM is trained using the model size MS, the training data TD, the target language ratio LR, the target language data amount LD, and the epoch number EN.

### (Correction Unit 14)

The correction unit 14 corrects the loss predicted by the prediction unit 12. The correction unit 14 stores the corrected loss in the storage unit 20. As an example, the correction unit 14 corrects the loss predicted by the prediction unit 12 with reference to the model size MS, the target language data amount LD, and the epoch number EN. As described above, the loss predicted by the prediction unit 12 shifts upward according to the model size MS, the target language data amount LD, and the epoch number EN. Therefore, the correction unit 14 corrects the loss predicted by the prediction unit 12 to calculate a loss after the loss predicted by the prediction unit 12 has an upward shift.

More specifically, assuming that the value of the model size MS is N, the value of the training data amount TD is D, the value of the target language ratio LR is r, the value of the target language data amount LD is D_repeat, and the value of the epoch number EN is k, the correction unit 14 calculates the value L* of the loss after correction using the following Expression (4).

$${L}^{*} = g ( f ( N , D ) \times r \hat{} d , N , D\_repeat , k ) \qquad ( 4 )$$

As an example, assuming that the loss predicted by the prediction unit 12 is L, and that L* is a correction value calculated by adding a value to L, Expression (4) can be rewritten to the following Expression (5).

$${L}^{*} = L + h ( N , D\_repeat , k ) \qquad ( 5 )$$

As described above, if D_repeat is the same, the degree of the upward shift of loss increases as the model size increases. Therefore, Expression (5) can be rewritten as the following Expression (6).

$${L}^{*} = L + h ( D\_repeat / N , k ) \qquad ( 6 )$$

As an example of a method of calculating h (D_repeat/N, k), there is a method in which the correction unit 14 uses a difference between the loss L predicted by the prediction unit 12 and the loss L* measured in advance using a plurality of sets including the model size MS, the target language data amount LD, and the epoch number EN and having at least one different value.

As an example of the configuration, there is a method in which the correction unit 14 corrects the loss using k-nearest neighbor regression. More specifically, the LLM is trained in advance using a plurality of sets of the value N* of the model size MS, the value D_repeat* of the target language data amount LD, and the value k* of the epoch number EN, at least one value of which is different, and each loss L* is measured. The difference (L*−L) between the loss L* measured in this case and the relevant loss predicted in advance by the prediction unit 12 is stored in the form of (D_repeat*/N*, k*, L*−L).

Then, for the model size MS, the target language data amount LD, and the epoch number EN to be used for correction, the correction unit 14 extracts n (D_repeat*/N*, k*, L*) in order of proximity to these values, and calculates an average of the extracted n(L*−L) as a value of h(D_repeat/N, k). With this configuration, the correction unit 14 can suitably calculate the value L* of the corrected loss.

The correction unit 14 may be configured to correct the loss in a case where the epoch number EN is equal to or greater than a predetermined value. As described above, in a case where the number of epochs is small, the influence of overfitting is small, and an upward shift of loss hardly occurs. Therefore, the correction unit 14 corrects the loss in a case where the epoch number EN is a predetermined value (for example, 4) or more, and does not correct the loss in a case where the epoch number EN is less than the predetermined value. With this configuration, the correction unit 14 can reduce the processing load.

### (Processing Executed by Prediction Device 1A)

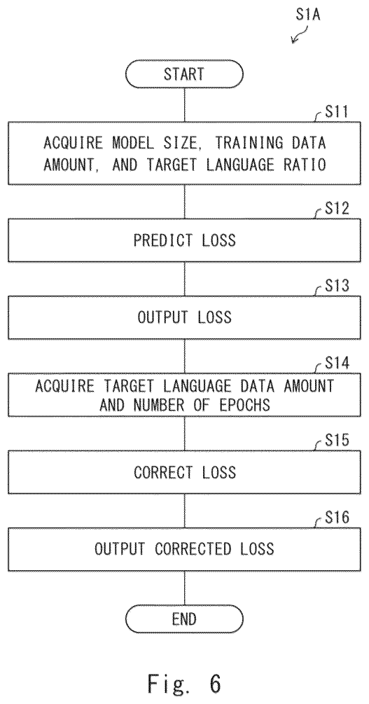

A flow of processing (prediction method S1A) performed by the prediction device 1A will be described with reference to FIG. 6. FIG. 6 is a flowchart illustrating a flow of the prediction method S1A.

### (Acquisition Processing S11)

In the acquisition processing S11, the acquisition unit 11 acquires the model size MS, the training data amount TD, and the target language ratio LR. The acquisition unit 11 stores the acquired model size MS, training data amount TD, and target language ratio LR in the storage unit 20.

### (Prediction Processing S12)

In the prediction processing S12, the prediction unit 12 predicts the loss of an LLM with reference to the model size MS, the training data amount TD, and the target language ratio LR. The prediction unit 12 stores the predicted loss in the storage unit 20. The method by which the prediction unit 12 predicts the LLM loss is as described above.

### (Output Processing S13)

In the output processing S13, the output unit 13 outputs information indicating the loss predicted by the prediction unit 12.

### (Step S14)

In step S14, the acquisition unit 11 acquires the target language data amount LD and the epoch number EN. The acquisition unit 11 stores the acquired target language data amount LD and the acquired epoch number EN in the storage unit 20.

### (Step S15)

In step S15, the correction unit 14 corrects the loss predicted by the prediction unit 12 with reference to the model size MS, the target language data amount LD, and the epoch number EN. The correction unit 14 stores the corrected loss in the storage unit 20. The method by which the correction unit 14 corrects the loss is as described above.

### (Output Processing S16)

In output processing S16, the output unit 13 outputs information indicating the loss corrected by the correction unit 14.

### (Application Example of Prediction Device 1A)

For example, the prediction device 1A may train the LLM using the model size MS, the training data amount TD, the target language ratio LR, the target language data amount LD, and the epoch number EN. As a method of training the LLM, a known method may be used. In a case where the prediction device 1A trains the LLM, the prediction device 1A may train the LLM after performing processing of determining various learning settings such as the calculation resource amount used for the learning processing. As a result, it is possible to reduce the search space in which the model size is changed in order to generate a higher-performance LLM.

The prediction device 1A may instruct an external device different from the prediction device 1A to train the LLM. In this case, the prediction device 1A may instruct an external device to narrow a range for selecting various learning settings using the predicted loss. With this configuration, the prediction device 1A can reduce, with respect to the external device, the search space in which the loss is changed.

### (Effects of Prediction Device 1A)

As described above, in the prediction device 1A, the loss of an LLM is predicted with reference to the model size MS, the training data amount TD, and the target language ratio LR. Therefore, the prediction device 1A can predict the performance of an LLM in a case where the LLM is trained using a plurality of languages.

The prediction device 1A refers to the model size MS, the epoch number EN, and the target language data amount LD, and corrects the predicted loss. As described above, the predicted loss shifts upward depending on the model size MS, the epoch number EN, and the target language data amount LD. Since the prediction device 1A can calculate the prediction value after the upward shift, it is possible to accurately predict the performance of the LLM in a case where the LLM is trained using a plurality of languages.

### [Achievement Example by Software]

Some or all of the functions of the prediction devices 1 and 1A (hereinafter, also referred to as “each of the above devices”) may be implemented by hardware such as an integrated circuit (IC chip) or may be implemented by software.

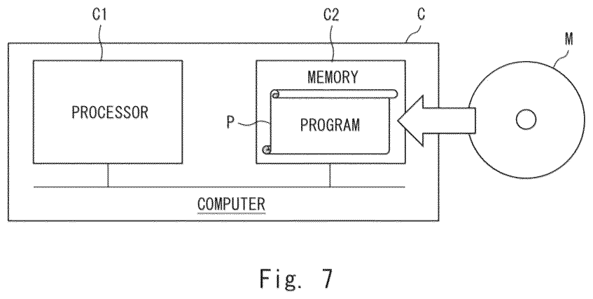

In the latter case, each of the above devices is achieved by, for example, a computer that executes a command of a program as software for achieving each function. An example of such a computer (hereinafter, referred to as a computer C) is illustrated in FIG. 7. FIG. 7 is a block diagram illustrating a hardware configuration of the computer C functioning as each of the above devices.

The computer C includes at least one processor C1 and at least one memory C2. A program P causing the computer C to operate as each of the above devices is recorded in the memory C2. In the computer C, by the processor C1 reading the program P from the memory C2 and executing the program P, each function of each of the above devices is achieved. As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used. The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### [Supplementary Information A]

The present disclosure includes technologies described in the following Supplementary Notes. However, the present disclosure is not limited to the techniques described in the following supplementary notes, and various modifications can be made within the scope described in the claims.

### (Supplementary Note A1)

A prediction device including:
an acquisition means for acquiring a model size of a language model for a target language to be trained using a plurality of languages, a training data amount used for learning processing of the language model, and a target language ratio indicating a ratio of a data amount of the target language in the training data amount; and
a prediction means for predicting a loss of the language model by using a product of a function depending on the model size and the training data amount and a constant power of the target language ratio.

### (Supplementary Note A2)

The prediction device according to Supplementary Note A1, in which
the acquisition means acquires a number of epochs and a data amount of a target language to be repeated in the learning processing, and
the prediction device further includes a correction means for correcting the loss with reference to the model size, the number of epochs, and a data amount of the repeated target language.

### (Supplementary Note A3)

The prediction device according to Supplementary Note A2, in which the correction means uses a difference between a loss predicted by the prediction means and a loss measured in advance using a plurality of sets including the model size, the data amount of the target language, and the number of epochs, the sets having at least one different value.

### (Supplementary Note A4)

The prediction device according to Supplementary Note A3, in which the correction means corrects the loss using k-nearest neighbor regression.

### (Supplementary Note A5)

The prediction device according to any one of Supplementary Note A2 to A4, in which the correction means corrects the loss in a case where the number of epochs is equal to or greater than a predetermined value.

### (Supplementary Note A6)

The prediction device according to any one of Supplementary Notes A1 to A5, further including an output means for outputting information indicating the loss.

### [Supplementary Information B]

The present disclosure includes technologies described in the following Supplementary Notes. However, the present disclosure is not limited to the techniques described in the following supplementary notes, and various modifications can be made within the scope described in the claims.

### (Supplementary Note B1)

A prediction method including:
acquisition processing of acquiring, by at least one processor, a model size of a language model for a target language to be trained using a plurality of languages, a training data amount used for learning processing of the language model, and a target language ratio indicating a ratio of a data amount of the target language in the training data amount; and
prediction processing of predicting, by the at least one processor, a loss of the language model by using a product of a function depending on the model size and the training data amount and a constant power of the target language ratio.

### (Supplementary Note B2)

The prediction method according to Supplementary Note B1, wherein
the acquisition processing includes acquiring, by the at least one processor, a number of epochs and a data amount of a target language to be repeated in the learning processing, and
the prediction method further includes correction processing of correcting, by the at least one processor, the loss with reference to the model size, the number of epochs, and a data amount of the repeated target language.

### (Supplementary Note B3)

The prediction device according to Supplementary Note B2, in which in the correction processing, the at least one processor uses a difference between a loss predicted in the prediction processing and a loss measured in advance using a plurality of sets including the model size, the data amount of the target language, and the number of epochs, the sets having at least one different value.

### (Supplementary Note B4)

The prediction method according to Supplementary Note B3, in which in the correction processing, the at least one processor corrects the loss using k-nearest neighbor regression.

### (Supplementary Note B5)

The prediction method according to any one of Supplementary Note B2 to B4, in which in the correction processing, the at least one processor corrects the loss in a case where the number of epochs is equal to or greater than a predetermined value.

### (Supplementary Note B6)

The prediction method according to any one of Supplementary Notes B1 to B5, in which the at least one processor is further configured to execute output processing of outputting information indicating the loss.

### [Supplementary Information C]

The present disclosure includes technologies described in the following Supplementary Notes. However, the present disclosure is not limited to the techniques described in the following supplementary notes, and various modifications can be made within the scope described in the claims.

### (Supplementary Note C1)

A prediction program for causing a computer to function as a prediction device, the program causing the computer to function as:
an acquisition means for acquiring a model size of a language model for a target language to be trained using a plurality of languages, a training data amount used for learning processing of the language model, and a target language ratio indicating a ratio of a data amount of the target language in the training data amount; and
a prediction means for predicting a loss of the language model by using a product of a function depending on the model size and the training data amount and a constant power of the target language ratio.

### (Supplementary Note C2)

The prediction program according to Supplementary Note C1, in which
the acquisition means acquires a number of epochs and a data amount of a target language to be repeated in the learning processing, and
the prediction device causes the computer to function as a correction means for correcting the loss with reference to the model size, the number of epochs, and the data amount of the target language to be repeated.

### (Supplementary Note C3)

The prediction device according to Supplementary Note C2, in which the correction means uses a difference between a loss predicted by the prediction means and a loss measured in advance using a plurality of sets including the model size, the data amount of the target language, and the number of epochs, the sets having at least one different value.

### (Supplementary Note C4)

The prediction program according to Supplementary Note C3, in which the correction means corrects the loss using k-nearest neighbor regression.

### (Supplementary Note C5)

The prediction program according to any one of Supplementary Note C2 to C4, in which the correction means corrects the loss in a case where the number of epochs is equal to or greater than a predetermined value.

### (Supplementary Note C6)

The prediction program according to any one of Supplementary Notes C1 to C5, in which the computer further functions as an output means for outputting information indicating the loss.

### [Supplementary Information D]

The present disclosure includes technologies described in the following Supplementary Notes. However, the present disclosure is not limited to the technologies described in the following Supplementary Notes, and various modifications can be made within the scope described in the claims.

### (Supplementary Note D1)

A prediction device including at least one processor, in which
the processor is configured to execute:
acquisition processing of acquiring a model size of a language model for a target language to be trained using a plurality of languages, a training data amount used for learning processing of the language model, and a target language ratio indicating a ratio of a data amount of the target language in the training data amount; and
prediction processing of predicting a loss of the language model by using a product of a function depending on the model size and the training data amount and a constant power of the target language ratio.

The prediction device may further include a memory. The memory may store a program for causing the at least one processor to execute each of the processing.

### (Supplementary Note D2)

The prediction device according to Supplementary Note D1, in which
in the acquisition processing, the at least one processor acquires a number of epochs and a data amount of a target language to be repeated in the learning processing, and
the at least one processor is configured to further execute correction processing of correcting the loss with reference to the model size, the number of epochs, and a data amount of the repeated target language.

### (Supplementary Note D3)

The prediction device according to Supplementary Note D2, in which in the correction processing, the at least one processor uses a difference between a loss predicted in the prediction processing and a loss measured in advance using a plurality of sets including the model size, the data amount of the target language, and the number of epochs, the sets having at least one different value.

### (Supplementary Note D4)

The prediction device according to Supplementary Note D3, in which in the correction processing, the at least one processor corrects the loss using k-nearest neighbor regression.

### (Supplementary Note D5)

The prediction device according to any one of Supplementary Note D2 to D4, in which in the correction processing, the at least one processor corrects the loss in a case where the number of epochs is equal to or greater than a predetermined value.

### (Supplementary Note D6)

The prediction device according to any one of Supplementary Notes D1 to D5, in which the at least one processor is further configured to execute output processing of outputting information indicating the loss.

### [Supplementary Information E]

The present disclosure includes technologies described in the following Supplementary Notes. However, the present disclosure is not limited to the techniques described in the following supplementary notes, and various modifications can be made within the scope described in the claims.

### (Supplementary Note E1)

A non-transitory recording medium having stored therein a prediction program for causing a computer to function as a prediction device, the program causing the computer to execute:
acquisition processing of acquiring a model size of a language model for a target language to be trained using a plurality of languages, a training data amount used for learning processing of the language model, and a target language ratio indicating a ratio of a data amount of the target language in the training data amount; and
prediction processing of predicting a loss of the language model by using a product of a function depending on the model size and the training data amount and a constant power of the target language ratio.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. A prediction device comprising:
a memory that stores instructions; and
a processor that is configured, according to the instructions, to execute:
acquiring a model size of a language model for a target language to be trained using a plurality of languages, a training data amount used for learning processing of the language model, and a target language ratio indicating a ratio of a data amount of the target language in the training data amount; and
predicting a loss of the language model by using a product of a function depending on the model size and the training data amount and a constant power of the target language ratio.

2. The prediction device according to claim 1, wherein
the acquiring includes acquiring a number of epochs and a data amount of a target language to be repeated in the learning processing, and
the processor is further configured to execute correcting the loss with reference to the model size, the number of epochs, and a data amount of the repeated target language.

3. The prediction device according to claim 2, wherein the correcting uses a difference between a loss predicted in the predicting and a loss measured in advance using a plurality of sets including the model size, the data amount of the target language, and the number of epochs, the sets having at least one different value.

4. The prediction device according to claim 3, wherein the correcting includes correcting the loss using k-nearest neighbor regression.

5. The prediction device according to claim 2, wherein in the correcting, the loss is corrected in a case where the number of epochs is equal to or greater than a predetermined value.

6. The prediction device according to claim 1, wherein the processor is further configured to execute outputting information indicating the loss.

7. A prediction method comprising:
acquisition processing of acquiring, by at least one processor, a model size of a language model for a target language to be trained using a plurality of languages, a training data amount used for learning processing of the language model, and a target language ratio indicating a ratio of a data amount of the target language in the training data amount; and
prediction processing of predicting, by the at least one processor, a loss of the language model by using a product of a function depending on the model size and the training data amount and a constant power of the target language ratio.

8. The prediction method according to claim 7, wherein
the acquisition processing includes acquiring a number of epochs and a data amount of a target language to be repeated in the learning processing, and
the prediction method further comprises correction processing of correcting the loss with reference to the model size, the number of epochs, and a data amount of the repeated target language.

9. The prediction method according to claim 8, wherein the correction processing uses a difference between a loss predicted in the prediction processing and a loss measured in advance using a plurality of sets including the model size, the data amount of the target language, and the number of epochs, the sets having at least one different value.

10. The prediction method according to claim 9, wherein the correction processing corrects the loss using k-nearest neighbor regression.

11. The prediction method according to claim 8, wherein the correction processing corrects the loss in a case where the number of epochs is equal to or greater than a predetermined value.

12. The prediction method according to claim 7, further comprising output processing of outputting information indicating the loss.

13. A non-transitory computer readable medium having stored therein a prediction program for supporting decision making for causing a computer to function as a prediction device, the program causing the computer to function as:
an acquisition means for acquiring a model size of a language model for a target language to be trained using a plurality of languages, a training data amount used for learning processing of the language model, and a target language ratio indicating a ratio of a data amount of the target language in the training data amount; and
a prediction means for predicting a loss of the language model by using a product of a function depending on the model size and the training data amount and a constant power of the target language ratio.

14. The non-transitory computer readable medium having stored therein a prediction program for supporting decision making according to claim 13, wherein
the acquisition means acquires a number of epochs and a data amount of a target language to be repeated in the learning processing, and
the prediction device further includes a correction means for correcting the loss with reference to the model size, the number of epochs, and the data amount of the target language to be repeated.

15. The non-transitory computer readable medium having stored therein a prediction program for supporting decision making according to claim 14, wherein the correction means uses a difference between a loss predicted by the prediction means and a loss measured in advance using a plurality of sets including the model size, the data amount of the target language, and the number of epochs, the sets having at least one different value.

16. The non-transitory computer readable medium having stored therein a prediction program for supporting decision making according to claim 15, wherein the correction means corrects the loss using k-nearest neighbor regression.

17. The non-transitory computer readable medium having stored therein a prediction program for supporting decision making according to claim 14, wherein the correction means corrects the loss in a case where the number of epochs is equal to or greater than a predetermined value.

18. The non-transitory computer readable medium having stored therein a prediction program for supporting decision making according to claim 13, wherein further the program causing the computer to function as:
an output means for outputting information indicating the loss.
